(19) United States
(12) Patent Application Publication
(10) Pub. No.: US 2022/0180640 A1
(43) Pub. Date: Jun. 9, 2022

(54) ELECTRONIC DEVICE FOR PROVIDING RESPONSE METHOD, AND OPERATING METHOD THEREOF

(71) Applicant: SAMSUNG ELECTRONICS CO., LTD., Suwon-si, Gyeonggi-do (KR)

(72) Inventors: Seongwoo OH, Suwon-si, Gyeonggi-do (KR); Yoonhee CHOI, Suwon-si, Gyeonggi-do (KR); Jinyoung HWANG, Suwon-si, Gyeonggi-do (KR)

(21) Appl. No.: 17/436,771

(22) PCT Filed: Feb. 17, 2020
(86) PCT No.: PCT/KR2020/002181

§ 371 Date: Sep. 7, 2021

(30) Foreign Application Priority Data
Mar. 8, 2019 (KR) 10-2019-0027022

(51) Int. Cl. G06V 20/52; G06V 40/16; G06V 40/20; G06Q 30/06

(52) U.S. Cl. CPC G06V 20/52; G06V 40/168; G06Q 30/0641; G06V 40/174; G06V 40/20; G06V 40/178

(57) ABSTRACT

The present disclosure relates to an electronic device for providing a response method for a customer and an operating method thereof. For example, disclosed is a method, performed by an electronic device, of providing a response method for a customer, the method including: acquiring a captured image of the customer from at least one camera provided; acquiring an identification value of a camera having provided the image; determining a gaze direction in which the customer is gazing, based on facial features of the customer in the image; acquiring display information about products; identifying a displayed product corresponding to the gaze direction among displayed products around the camera, based on the display information; and providing a response method related to the displayed product.

### CROSS-REFERENCE TO RELATED APPLICATIONS

This application is a national stage of International Application No. PCT/KR2020/002181 designating the United States, filed on Feb. 17, 2020, in the Korean Intellectual Property Receiving Office and claiming priority to Korean Patent Application No. 10-2019-0027022, filed on Mar. 8, 2019, in the Korean Intellectual Property Office, the disclosures of which are incorporated by reference herein in their entireties.

### BACKGROUND

### Field

The disclosure relates to an electronic device for providing a response method and an operating method thereof. For example, the present disclosure relates to an electronic device for providing a response method for a customer in a store and an operating method thereof.

### Description of Related Art

Techniques have been developed for improving sales of a store by analyzing various pieces of information such as a customer visit history, purchase patterns, and a customer's movements in various types of stores selling products, such as a department store, a superstore, and a convenience store.

However, because general store management techniques simply track only customers' movements and analyze the tracked customers' movements but do not variously utilize which product a customer is actually interested in, the customer's behavior, the customer's characteristics, and the like, it is difficult to correctly catch the customer's purchase tendencies.

In addition, some solutions developed for general store management include only functions of displaying simple information such as movements, stay information, and the like of a customer, and thus, there is a demand for development of technology for improving sales, correctly perceiving characteristics of a customer, and providing a customized customer response method based on the perceived characteristics of the customer.

### SUMMARY

Embodiments of the disclosure provide an electronic device for providing a response method for a customer.

Embodiments of the disclosure provide an electronic device for providing a response method for a customer based on a gaze direction of the customer in a store.

According to an example embodiment of the present disclosure, there is provided a method, performed by an electronic device, of providing a response method for a customer, the method including: acquiring a captured image of the customer from at least one camera; acquiring an identification value of the camera having provided the image; determining a gaze direction in which the customer is gazing, based on facial features of the customer in the image; acquiring display information about products in the store; identifying a displayed product corresponding to the gaze direction among displayed products around the camera, based on the display information; and providing a response method related to the displayed product.

The determining of the gaze direction may include: identifying a facial area of the customer in the image; determining at least one object in the identified facial area; identifying at least one of a direction of a face of the customer and a direction of a pupil in the face using the at least one object; and determining the gaze direction using the identified at least one of the direction of the face and the direction of the pupil.

The identifying of the displayed product may include: determining a location of the camera having provided the image by mapping the acquired identification value to the display information; identifying a location of the customer in the image; and identifying the displayed product corresponding to the identified location of the customer, the determined location of the camera, and the gaze direction.

The identifying of the displayed product may include: determining a distance between the camera and the customer based on the location of the customer in the image and the determined location of the camera; identifying a location in the store corresponding to the determined distance and the gaze direction; and identifying the displayed product by mapping, to the display information, the location in the store corresponding to the determined distance and the gaze direction.

The method may further include: acquiring profile information of the customer based on the facial features of the customer in the image; acquiring information about a gaze time for which the customer gazes at the displayed product; determining preference information of the customer about the displayed product based on the profile information, the information about the gaze time, and the display information; and determining the response method based on the determined preference information of the customer.

The method may further include: acquiring behavior information of the customer based on body features of the customer in the image; and determining the preference information of the customer based on at least one of the acquired behavior information, the profile information, the information about the gaze time, and the display information.

The providing of the response method may include: determining a response time point for responding to the customer, a response subject for responding to the customer, and a response type based on the identified displayed product; and determining the response method using at least one of the response time point, the response subject, and the response type.

The providing of the response method may include: determining a response time point for responding to the customer, a response subject for responding to the customer, and a response type based on the profile information, the behavior information, and the preference information of the customer; and determining the response method using at least one of the response time point, the response subject, and the response type.

The preference information of the customer may be generated in a map form by reflecting information about the gaze time in the display information, and the preference information of the customer may be generated for each predetermined display area in the store and for each product in the store.

The display information may include at least one of information about locations of the products displayed, information about locations of display stands for displaying the products, and information about a location of the camera for acquiring the image of the customer, and the method may further include providing guidance information for updating the display information, based on the acquired preference information of the customer.

The profile information may include at least one of age information of the customer and gender information of the customer, which are determined based on the facial features of the customer, and the behavior information may include at least one of expression information of the customer and gesture information of the customer, which are determined based on at least one of the facial features and body features of the customer.

According to an example embodiment of the present disclosure, there is provided an electronic device for providing a response method for a customer, the electronic device including: a communication interface comprising communication circuitry; a memory storing one or more instructions; and a processor configured to control the electronic device by executing the one or more instructions, wherein the processor is configured to: acquire a captured image of the customer from at least one camera, acquire an identification value of the camera having provided the image, determine a gaze direction in which the customer is gazing based on facial features of the customer in the image, acquire display information about products in the store, identify a displayed product corresponding to the gaze direction among displayed products around the camera, based on the display information, and provide a response method related to the identified displayed product.

The processor may be further configured to: identify a facial area of the customer in the image, determine at least one object in the identified facial area, identify at least one of a direction of a face of the customer and a direction of a pupil in the face using the at least one object, and determine the gaze direction using the identified at least one of the direction of the face and the direction of the pupil.

The processor may be further configured to: determine a location of the camera having provided the image by mapping the acquired identification value to the display information, identify a location of the customer in the image, and identify the displayed product corresponding to the identified location of the customer, the determined location of the camera, and the gaze direction.

The processor may be further configured to: determine a distance between the camera and the customer based on the location of the customer in the image and the determined location of the camera, identify a location in the store corresponding to the determined distance and the gaze direction, and identify the displayed product by mapping, to the display information, the location in the store corresponding to the determined distance and the gaze direction.

The processor may be further configured to: acquire profile information of the customer based on the facial features of the customer in the image, acquire information about a gaze time for which the customer gazes at the displayed product, determine preference information of the customer about the displayed product in the store based on the profile information, the information about the gaze time, and the display information, and determine the response method based on the determined preference information of the customer.

The processor may be further configured to: acquire behavior information of the customer based on body features of the customer in the image and determine the preference information of the customer based on at least one of the acquired behavior information, the profile information, the information about the gaze time, and the display information.

The processor may be further configured to: determine a response time point for responding to the customer, a response subject for responding to the customer, and a response type based on the profile information, the behavior information, and the preference information of the customer and determine the response method using at least one of the response time point, the response subject, and the response type.

The preference information of the customer may be generated in a map form by reflecting information about the gaze time in the display information, and the preference information of the customer may be generated for each predetermined display area in the store and for each product in the store.

The display information may include at least one of information about locations of the products displayed, information about locations of display stands for displaying the products, and information about a location of the camera for acquiring the image of the customer.

The profile information may include at least one of age information of the customer and gender information of the customer, which are determined based on the facial features of the customer.

The behavior information may include at least one of expression information of the customer and gesture information of the customer, which are determined based on at least one of the facial features and body features of the customer.

The processor may be further configured to provide guidance information for updating the display information, based on the acquired preference information of the customer.

According to an example embodiment of the present disclosure, there is provided a computer program including instructions for performing operations of: acquiring, from at least one camera, an image, by photographing a customer; acquiring an identification value of the camera having provided the image; determining a gaze direction in which the customer is gazing, based on facial features of the customer in the image; acquiring display information about products; identifying a displayed product corresponding to the gaze direction among displayed products around the camera, based on the display information; and providing a response method related to the displayed product.

### BRIEF DESCRIPTION OF DRAWINGS

The above and other aspects, features and advantages of certain embodiments of the present disclosure will be more apparent from the following detailed description, taken in conjunction with the accompanying drawings, in which:

FIG. 1 is a diagram illustrating an example method, performed by an electronic device, of providing a response method for a customer in a store, according to various embodiments;

FIG. 2 is a diagram illustrating an example method for perceiving movements of a customer in a general store according to various embodiments;

FIG. 3 is a flowchart illustrating an example method, performed by an electronic device, of providing a response method for a customer in a store, according to various embodiments;

FIG. 4 is a flowchart illustrating an example method, performed by an electronic device, of determining a gaze direction of a customer, according to various embodiments;

FIG. 5 is a diagram illustrating an example method, performed by an electronic device, of determining a gaze direction of a customer, according to various embodiments;

FIG. 6 is a flowchart illustrating an example method, performed by an electronic device, of identifying a displayed product at which a customer is gazing, according to various embodiments;

FIG. 7 is a flowchart illustrating an example method, performed by an electronic device, of identifying a displayed product at which a customer is gazing, according to various embodiments;

FIG. 8 is a flowchart illustrating an example method, performed by an electronic device, of determining preference information of a customer and determining a response method based on the determined preference information, according to various embodiments;

FIG. 9 is a table illustrating example profile information and behavior information of a customer, acquired by an electronic device, according to various embodiments;

FIG. 10 is a flowchart illustrating an example method, performed by an electronic device, of determining a response method, according to various embodiments;

FIG. 11 is a table illustrating an example method, performed by an electronic device, of determining a response method, according to various embodiments;

FIG. 12 is a flowchart illustrating an example method, performed by an electronic device, of providing a response method for a customer, according to various embodiments;

FIG. 13 is a block diagram illustrating an example configuration of an electronic device for providing a response method for a customer in a store, according to various embodiments;

FIG. 14 is a block diagram illustrating an example configuration of an electronic device for providing a response method for a customer in a store, according to various embodiments;

FIG. 15 is a signal flow diagram illustrating an example method, performed by an electronic device, of providing a response method for a customer using a store server, according to various embodiments; and

FIG. 16 is a block diagram illustrating an example configuration of a store server according to various embodiments.

### DETAILED DESCRIPTION

The terms used in the disclosure will be schematically described, and then, the present disclosure will be described in detail.

The terms used in the present disclosure are those general terms currently widely used in the art, but the terms may vary according to the intention of those of ordinary skill in the art, precedents, or new technology in the art. Also, specified terms may be selected by the applicant, and in this case, the detailed meaning thereof will be described in the detailed description. Thus, the terms used in the present disclosure should be understood not as simple names but based on the meaning of the terms and the overall description.

Throughout the disclosure, it will also be understood that when a component “includes” an element, unless there is another opposite description thereto, it should be understood that the component does not exclude another element but may further include another element. In addition, terms such as “ . . . unit”, “ . . . module”, and the like refer to units that perform at least one function or operation, and the units may be implemented as hardware or software or as a combination of hardware and software.

Hereinafter, various example embodiments will be described in detail with reference to the accompanying drawings. However, the present disclosure may be embodied in many different forms and should not be construed as being limited to the embodiments set forth herein. In the drawings, parts irrelevant to the description may be omitted to clearly describe the present disclosure, and like reference numerals denote like elements throughout the disclosure.

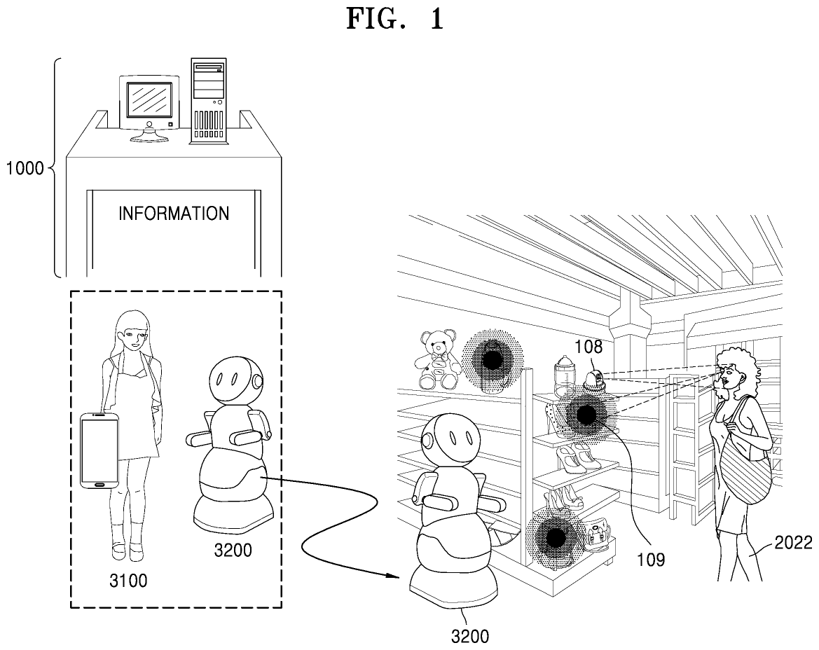

FIG. 1 is a diagram illustrating an example method, performed by an electronic device 1000, of providing a response method for a customer in a store, according to various embodiments.

The electronic device 1000 according to an embodiment may identify a displayed product at which a customer 2022 (in the store is gazing, and determine a response method related to the identified displayed product. The electronic device 1000 may transmit the determined response method to a terminal 3100 which a clerk in the store carries or to a mobile robot 3200 for responding to the customer 2022. The clerk carrying the terminal 3100 or the mobile robot 3200 may respond to the customer 2022 according to the response method provided by the electronic device 1000.

The electronic device 1000 according to an embodiment may acquire an image of the customer 2022, which at least one camera 108 provided in the store has captured, determine a gaze direction in which the customer 2022 in the acquired image is gazing, identify a displayed product corresponding to the determined gaze direction and previously determined display information, and provide a response method related to the identified displayed product. According to an embodiment, the camera 108 may be located on a display stand in the store, on which products are displayed, but is not limited thereto. According to an embodiment, the camera 108 may be located on the ceiling in the store to acquire an image of the customer 2022 and determine a gaze direction in which the customer 2022 in the acquired image is gazing.

For example, unlike a general store management device, the electronic device 1000 may identify a gaze direction in which the customer 2022 is gazing, and accurately identify preference information of the customer 2022 by identifying a displayed product 109 corresponding to the identified gaze direction and display information. The electronic device 1000 may provide a customized customer 2022 response method based on the accurately identified preference information of the customer 2022.

The electronic device 1000 according to an embodiment may be implemented in various forms. For example, the electronic device 1000 described in the present disclosure may be a mobile terminal, a smartphone, a laptop computer, a tablet personal computer (PC), an e-book terminal, a digital broadcast terminal, a personal digital assistant (PDA), a portable multimedia player (PMP), or the like but is not limited thereto.

The electronic device 1000 described in the present disclosure may be a store server located in the store, a computer device on a service desk in the store, or a computer device managed separately from the store server. According to an embodiment, the electronic device 1000 may be a server outside the store, which is electrically connected to another electronic device for providing a response method in the store. Hereinafter, for convenience of description, a case in which the electronic device 1000 is a computer device for determining a response method in the store will be described as an example.

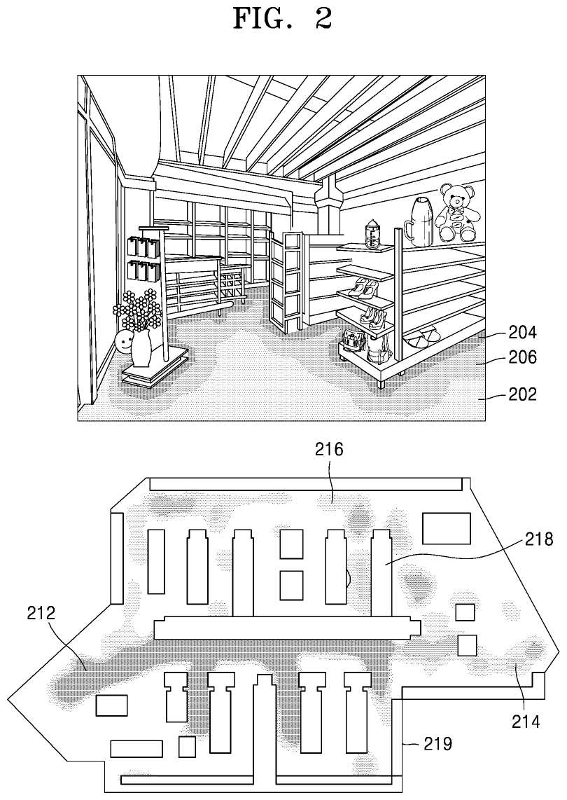

FIG. 2 is a diagram illustrating an example method for perceiving movements of a customer in a general store according to various embodiments.

In general, a plurality of techniques for analyzing a tendency of a customer in a store and performing customized marketing according to the analyzed tendency of the customer have been developed. For example, a general store management system tracks a location of a customer in a store 219 and determines a moving path of the customer based on the tracked location of the customer. In addition, the general store 219 management system measures a stay time for which the customer stays on the moving path, grades display areas identified based on display stands 218 in the store 219, generates a heat map based on the graded areas in the store 219, and determines an area of interest of the customer using the generated heat map.

That is, the general store management system may determine an area which the customer prefers by grading areas in the store 219, in which the customer stays for a long time, as a first area 204 and 212, a second area 206 and 214, and a third area 202 and 216. However, the general store management system may determine only the preferred area of the customer based on a location of the customer, but has a problem in that it cannot be correctly identified which product the customer actually prefers.

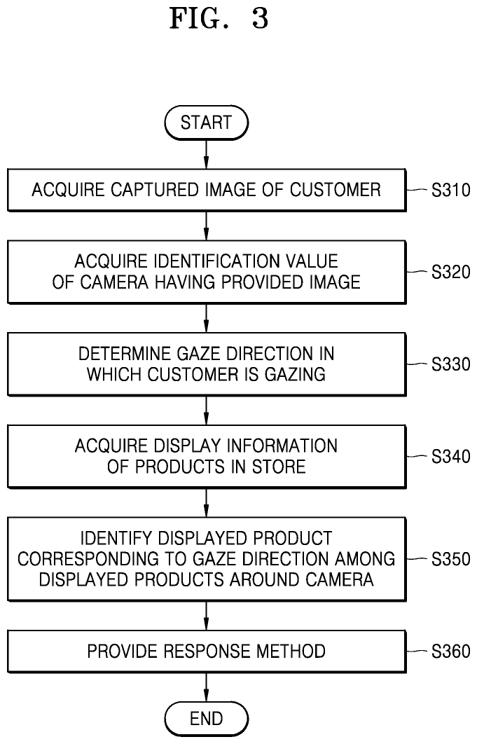

FIG. 3 is a flowchart illustrating an example method, performed by an electronic device, of providing a response method for a customer in a store, according to various embodiments.

In operation S310, the electronic device 1000 may acquire a captured image of the customer from at least one camera provided in the store. According to an embodiment, the at least one camera provided in the store may be a closed-circuit television (CCTV) capable of capturing an image in real-time but is not limited thereto. That is, the at least one camera provided in the store may be a certain image capturing device capable of photographing a customer in the store. The electronic device 1000 may be connected to the at least one camera in the store in a wired or wireless manner and receive a captured image of a customer in real-time or at preset time intervals.

In operation S320, the electronic device 1000 may acquire an identification value of a camera having provided the image. For example, the electronic device 1000 may acquire an identification value preset for each camera in the store and identify cameras in the store using the acquired identification values. According to an embodiment, the identification value of the camera may be included in the captured image of the customer, which the electronic device 1000 receives from the camera. As described below, the identification value of the camera may be included in display information which the electronic device 1000 acquires.

In operation S330, the electronic device 1000 may determine a gaze direction in which the customer is gazing, based on facial features of the customer in the image. The electronic device 1000 may identify a facial area of the customer in the image, determine facial features of the customer using at least one object included in the identified facial area, and determine a gaze direction based on the determined facial features.

According to an embodiment, the electronic device 1000 may identify a face of the customer in the image and determine a gaze direction in which the customer is gazing, using a deep learning algorithm having a neural network structure having several layers. Deep learning may be basically formed in a deep neural network structure having several layers. A neural network used by the electronic device 1000 according to an embodiment may include a convolutional neural network (CNN), a deep neural network (DNN), a recurrent neural network (RNN), or a bidirectional recurrent deep neural network (BRDNN) but is not limited thereto.

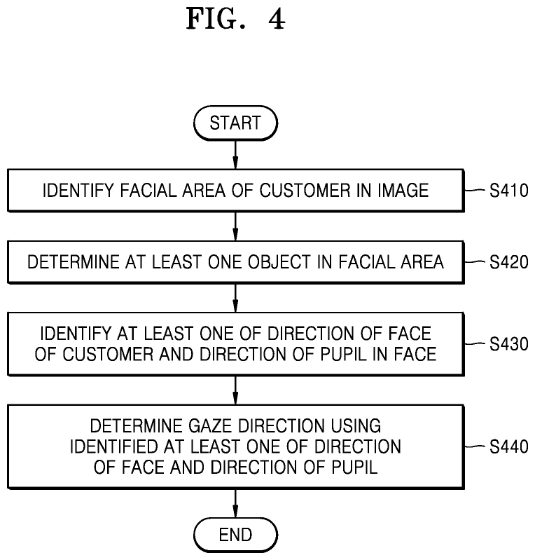

According to an embodiment, the neural network used by the electronic device 1000 may have a structure in which a fully-connected layer is connected to a CNN structure in which a convolution layer and a pooling layer are repeatedly used. According to an embodiment, the electronic device 1000 may use a plurality of neural networks to identify a gaze direction in which the customer in the image is gazing. According to an embodiment, the electronic device 1000 may determine facial features and body features of the customer from the image of the customer, which is captured by the camera, using a neural network model. A method, performed by the electronic device 1000, of determining a gaze direction of the customer will be described in detail with reference to FIG. 4.

In operation S340, the electronic device 1000 may acquire display information of products in the store. For example, the electronic device 1000 may acquire the display information of the products in the store from a store server or another server of a store manager, which is connected to the store server in a wired or wireless manner. According to an embodiment, the display information may be stored in advance in a memory of the electronic device 1000. According to an embodiment, the display information acquired by the electronic device 1000 may include at least one of information about locations of products displayed in the store, information about locations of display stands for displaying the products, and information about a location of a camera for acquiring the image of the customer. The information about the location of the camera in the store, which is included in the display information, may be identified by an identification value of the camera. According to an embodiment, when the customer in the image is a customer who visited the store in the past, the display information acquired by the electronic device 1000 may further include information about a visit history of the customer and a purchase history of the customer.

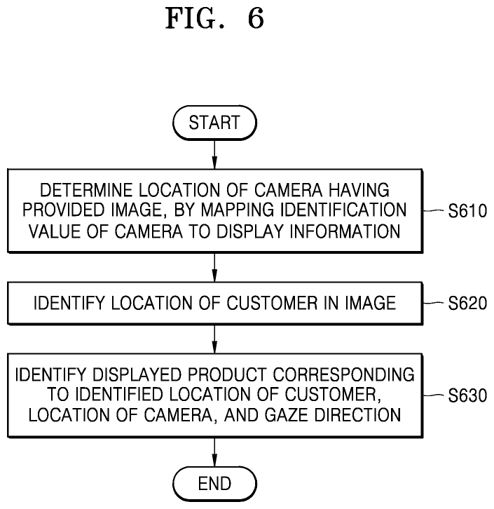

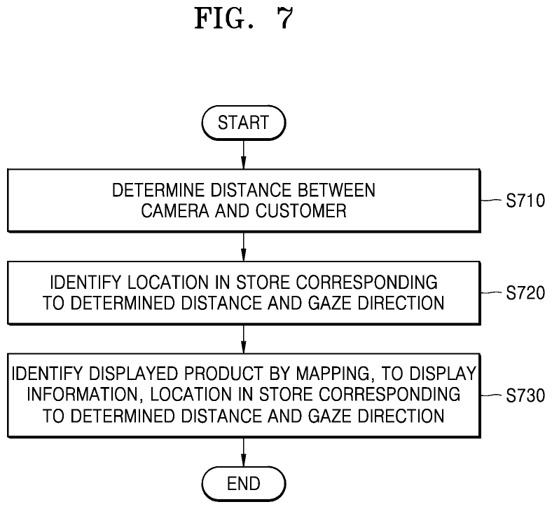

In operation S350, the electronic device 1000 may identify a displayed product corresponding to the gaze direction among displayed products around the camera having captured the image of the customer, based on the acquired display information. For example, the electronic device 1000 may determine a location of the camera using the acquired identification value of the camera and identify a location in the store corresponding to the location of the camera and the gaze direction of the customer in the image. In addition, the electronic device 1000 may identify the displayed product at which the customer is gazing, by mapping, to the display information, the location in the store corresponding to the location of the camera and the gaze direction of the customer in the image. A method, performed by the electronic device 1000, of identifying the displayed product will be described in detail with reference to FIGS. 6 and 7.

In operation S360, the electronic device 1000 may provide a response method related to the identified displayed product. According to an embodiment, the electronic device 1000 may determine a response time point indicating a time point for providing a response to the customer, a response subject for providing the response to the customer, and a response type related to a manner or content of the response. The electronic device 1000 may determine a response method using at least one of the determined response time point, response subject, and response type and provide the determined response method.

FIG. 4 is a flowchart illustrating an example method, performed by an electronic device, of determining a gaze direction of a customer, according to various embodiments.

In operation S410, the electronic device 1000 may identify a facial area of the customer from an image acquired from at least one camera in a store. According to an embodiment, the electronic device 1000 may extract facial feature points from a facial image of the customer and identify the facial area based on the extracted facial feature points. For example, the electronic device 1000 may extract the facial feature points in the image using a pre-trained CNN and identify the facial area based on the extracted facial feature points.

In operation S420, the electronic device 1000 may determine at least one object from the identified facial area based on the extracted facial feature points. According to an embodiment, an object determined by the electronic device 1000 may include at least one of a face outline object, an eye object, a nose object, a mouth object, and a pupil object but is not limited thereto.

In operation S430, the electronic device 1000 may identify at least one of a direction of a face of the customer and a direction of a pupil in the face using the determined at least one object. For example, the electronic device 1000 may set at least one reference line for each object using at least one feature point included in each object. The electronic device 1000 may identify the direction of the face of the customer and the direction of the pupil using the at least one reference line set for each object.

In operation S440, the electronic device 1000 may determine a gaze direction using the identified at least one of the direction of the face and the direction of the pupil. For example, the electronic device 1000 may determine the gaze direction in which the customer is gazing, using the direction of the face of the customer in the image or using the direction of the pupil of the customer in the image. According to an embodiment, the electronic device 1000 may determine the gaze direction using both the direction of the face of the customer in the image and the direction of the pupil thereof.

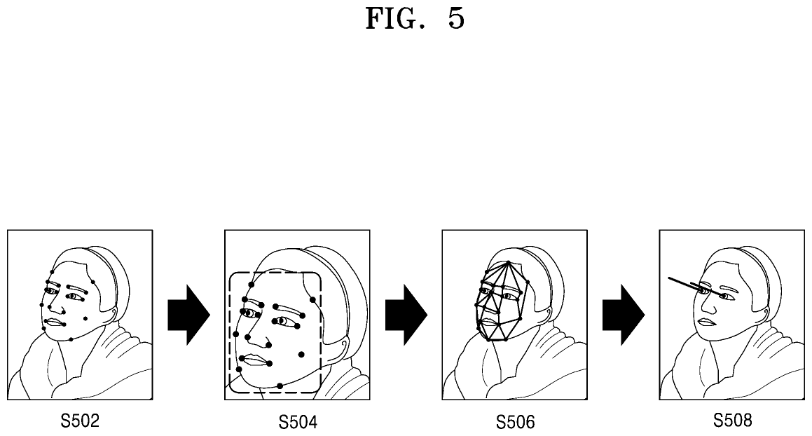

FIG. 5 is a diagram illustrating an example method, performed by an electronic device, of determining a gaze direction of a customer, according to various embodiments.

In operation S502, the electronic device 1000 may extract feature points from an image acquired from at least one camera in a store. According to an embodiment, the electronic device 1000 may extract facial feature points from the image using a pre-trained neural network model. According to an embodiment, the electronic device 1000 may extract feature points from an image of the customer using feature point extraction algorithms such as Harris corner, scale-invariant feature transform (SIFT), and FAST but is not limited thereto.

In operation S504, the electronic device 1000 may identify a facial area of the customer using the feature points extracted from the image. According to an embodiment, the electronic device 1000 may identify the facial area of the customer based on locations of the extracted feature points, relative locations among the extracted feature points, and a feature point distribution pattern determined based on the relative locations among the extracted feature points. According to an embodiment, the electronic device 1000 may identify the facial area of the customer using a neural network model pre-trained based on image learning data.

In operation S506, the electronic device 1000 may determine at least one object in the identified facial area. For example, the electronic device 1000 may generate feature vectors by connecting two or more feature points in the facial area and determine at least one object based on vector directions and locations of the generated feature vectors. According to an embodiment, the electronic device 1000 may determine at least one of a face outline object, a pupil object, a nose object, and a mouth object using a neural network model pre-trained based on image learning data.

In operation S508, the electronic device 1000 may determine a gaze direction using at least one of a direction of an identified face and a direction of a pupil. For example, the electronic device 1000 may generate one or more face reference lines using feature points in the face outline object and determine a direction of a face of the customer in the image using the generated face reference lines. In addition, the electronic device 1000 may generate one or more pupil reference lines using predetermined feature points in an eye object and determine a direction of a pupil of the customer in the image using the generated pupil reference lines.

According to an embodiment, facial features of the customer may indicate features of the face which may be identified based on directions of one or more objects identified in the facial area and relative locations and patterns of the one or more objects. For example, according to an embodiment, the facial features may include a distance between pupils, center coordinates between eyes, center coordinates of a nose, distances between both the pupils and the center of the nose, center coordinates of a lip, and the like.

According to an embodiment, the direction of the face of the customer and the direction of the pupil may be represented in a vector form. For example, the electronic device 1000 may determine a gaze direction of the customer by setting different weights for a facial direction vector and a pupil direction vector of the customer and weighted-summing the facial direction vector and the pupil direction vector according to the different weights set for the facial direction vector and the pupil direction vector.

FIG. 6 is a flowchart illustrating an example method, performed by an electronic device, of identifying a displayed product at which a customer is gazing, according to various embodiments.

In operation S610, the electronic device 1000 may determine a location of a camera having provided an image of the customer by mapping an identification value of the camera to display information. For example, the display information acquired by the electronic device 1000 may include not only information about locations of products in a store but also information about a location of at least one camera. Particularly, the at least one camera included in the display information may be identified by an identification value.

That is, the electronic device 1000 may identify the location of the camera having actually provided the image of the customer by mapping, to the display information, an identification value of the camera having provided the image. According to an embodiment, the mapping, performed by the electronic device 1000, of the identification value of the camera having provided the image to the display information may correspond to searching for, from the display information, an identification value matched with the identification value of the camera, which is acquired by the electronic device 1000.

In operation S620, the electronic device 1000 may identify a location of the customer in the image. For example, the electronic device 1000 may identify the location of the camera having provided the image of the customer and identify the location of the customer in the image provided from the identified camera. According to an embodiment, the location of the customer in the image provided from the camera may be determined as orthogonal coordinates in an orthogonal coordinate system having the origin as the center of the image provided from the camera or determined as circular coordinates in a circular coordinate system, but is not limited thereto.

In operation S630, the electronic device 1000 may identify a displayed product corresponding to the identified location of the customer in the image, the location of the camera, and a gaze direction. For example, the electronic device 1000 may determine a location in the store corresponding to the identified location of the customer in the image, the location of the camera, and the gaze direction and identify the displayed product by mapping, to the display information, the location in the store corresponding to the identified location of the customer in the image, the location of the camera, and the gaze direction.

FIG. 7 is a flowchart illustrating an example method, performed by an electronic device, of identifying a displayed product at which a customer is gazing, according to various embodiments.

In operation S710, the electronic device 1000 may determine a distance between a camera and the customer based on a location of the customer in an image and a determined location of the camera. For example, the electronic device 1000 may map, to display information, locations of the customer, displayed products, and display stands, on which the displayed products are displayed, in the image acquired by the camera based on the location of the camera. The electronic device 1000 may estimate actual locations of photographed objects in the image by mapping, to the display information, information about the locations of the customer, the displayed products, and the display stands, on which the displayed products are displayed, in the image acquired by the camera.

In operation S720, the electronic device 1000 may identify a location in a store corresponding to the distance between the location of the customer in the image and the camera and a gaze direction. For example, the electronic device 1000 may determine the distance between the customer in the image and the camera and determine a gaze direction in which the customer is gazing, based on facial features of the customer located at a distance away by the determined distance. The electronic device 1000 may identify a location (e.g., a gaze point) in the store, at which the customer is gazing, by tracking a gaze of the customer based on a direction in which the customer is gazing.

In operation S730, the electronic device 1000 may identify a displayed product by mapping, to display information, the location in the store corresponding to the distance between the customer and the camera and the gaze direction. Because operation S730 may correspond to operation S630 of FIG. 6, a detailed description thereof may not be repeated.

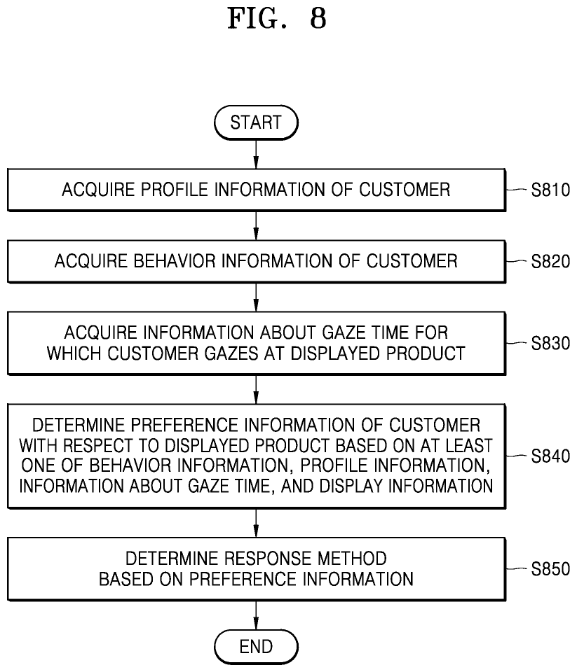

FIG. 8 is a flowchart illustrating an example method, performed by an electronic device, of determining preference information of a customer and determining a response method based on the determined preference information, according to various embodiments.

In operation S810, the electronic device 1000 may acquire profile information of the customer. For example, the electronic device 1000 may acquire the profile information of the customer using an image of the customer acquired from at least one camera provided in a store. According to an embodiment, the profile information of the customer may include at least one of age information or gender information of the customer.

According to an embodiment, the electronic device 1000 may identify a facial area of the customer from the image of the customer acquired from the at least one camera provided in the store and determine at least one object determined in the identified facial area. In addition, the electronic device 1000 may determine at least one of the gender information or the age information of the customer using facial features determined based on the at least one object.

According to an embodiment, the electronic device 1000 may match the facial features of the customer in the image with the gender information and the age information of the customer and store the matching result in a memory in the electronic device 1000, a memory in a store server, or the like. When the facial features acquired from the image of the customer in the store match pre-stored facial features of the customer, the electronic device 1000 may determine the age information and the gender information of the customer in a current image using the stored gender information and age information of the customer matched with the pre-stored facial features.

In operation S820, the electronic device 1000 may acquire behavior information of the customer based on body features of the customer in the image. For example, the electronic device 1000 may detect body feature points of the customer from the image of the customer acquired from the at least one camera in the store and identify a body area of the customer based on the detected body feature points. The electronic device 1000 may generate feature vectors using at least one body feature point in the identified body area and acquire the behavior information of the customer based on vector directions and vector locations of the generated feature vectors. For example, the electronic device 1000 may identify whether the customer repeatedly picks up and takes down a same product, whether the customer looks around, whether the customer repeatedly moves around two same points, and the like based on the body features of the customer in the image.

In operation S830, the electronic device 1000 may acquire information about a gaze time for which the customer gazes at a displayed product. For example, the electronic device 1000 may identify the displayed product by identifying a location in the store corresponding to a distance between a camera and the customer and a gaze direction and mapping the identified location in the store to display information. The electronic device 1000 may acquire an image of the customer in real-time using the at least one camera in the store and track a distance between the customer and the camera and a gaze direction of the customer in real-time from the acquired image of the customer.

In addition, the electronic device 1000 may acquire information about a gaze time for which the customer gazes at a displayed product, by measuring a time for which a location in the store corresponding to the real-time tracked distance between the customer and the camera and the real-time tracked gaze direction does not change. According to an embodiment, unchanging of the location in the store corresponding to the distance between the customer and the camera and the gaze direction may include a case where the location in the store corresponding to the distance between the customer and the camera and the gaze direction changes within a preset threshold range. That is, when a location in the store corresponding to a current distance between the camera and the customer and a current gaze direction changes only within a predetermined threshold range, the electronic device 1000 may determine that the location in the store corresponding to the current distance between the camera and the customer and the current gaze direction has not changed.

According to an embodiment, the electronic device 1000 may measure a real-time tracked location in the store corresponding to a distance between the customer and the camera and a gaze direction at preset time intervals. The electronic device 1000 may track a change in the displayed product at which the customer is gazing, by tracking locations in the store corresponding to a distance between the customer and the camera and a gaze direction, which change at the preset time intervals. According to an embodiment, the electronic device 1000 may measure a degree of concentration of the customer with respect to the displayed product, a stay time in the store, and a degree of interest according to a design or a shape of a same product by analyzing the gaze time of the customer with respect to the displayed product. In addition, the electronic device 1000 may determine a current sales efficiency of the store by measuring a stay time of the customer in the store, which is identified in the image, and determining a purchase rate of the customer according to the measured stay time.

In operation S840, the electronic device 1000 may determine preference information of the customer with respect to the displayed product in the store based on at least one of the profile information, the information about the gaze time, and display information. The preference information of the customer, which is acquired by the electronic device 1000, may be generated in a map form by reflecting the information about the gaze time in the display information, and the preference information of the customer may be generated for each predetermined display area in the store and for each product in the store. That is, the preference information of the customer may include the display information of the present application. According to an embodiment, the electronic device 1000 may determine the preference information of the customer based on at least one of the profile information, the behavior information, the information about the gaze time, and the display information.

According to an embodiment, the preference information of the customer may be represented by a heat map, and the heat map may indicate a predetermined area in the store with a different symbol or color according to a gaze time for which the customer gazes. For example, the heat map may indicate, with a dark color, an area in the store in which displayed products for which a gaze time of the customer with respect to a displayed product is measured to be long are located, and include information about a priority of the displayed product which the customer gazed for a long time. According to an embodiment, the preference information of the customer may include the profile information of the customer.

In operation S850, the electronic device 1000 may determine a response method based on the preference information. For example, the electronic device 1000 may determine a response subject, a response method, and a response type based on the preference information of the customer and determine the response method based on at least one of the determined response subject, response method, and response type. For example, when the determined preference information of the customer indicates that a currently identified customer is male in his thirties, and a displayed product at which the customer is gazing for the longest time is a game machine, the electronic device 1000 may provide a response method of allowing a mobile robot (e.g., a response subject) in the store to provide guidance information of the game machine (e.g., a response type) to the customer when 10 seconds elapses (e.g., a response time point) after the customer enters an area in which the game machine is displayed.

According to an embodiment, when the determined preference information of the customer indicates that a currently identified customer is female in her sixties, and a displayed product at which the customer is gazing for the longest time is a cosmetic product, the electronic device 1000 may provide a response method of allowing a clerk in the store to provide guidance information of the cosmetic product to the customer when 5 seconds elapses after the customer enters an area in which the cosmetic product is displayed. According to an embodiment, the electronic device 1000 may transmit the determined response method to a terminal which the clerk carries.

According to an embodiment, after operation S850, the electronic device 1000 may provide guidance information for updating the display information, based on the determined preference information of the customer. The electronic device 1000 according to the present disclosure may provide the guidance information for updating the display information, based on the determined preference information of the customer, so that a store manager adjusts locations of products in the store, locations of display stands on which the products are displayed, and the like based on the preference information of the customer.

In addition, the response method determined by the electronic device 1000 according to an embodiment, and the behavior information, the profile information, and the information about the gaze time of the customer, the display information, and the preference information of the customer, which are used to determine the response method, may be used for a purchase pattern analysis for customers who will visit the store in the future, and may allow a user to make an efficient store product display and display stand arrangement plan.

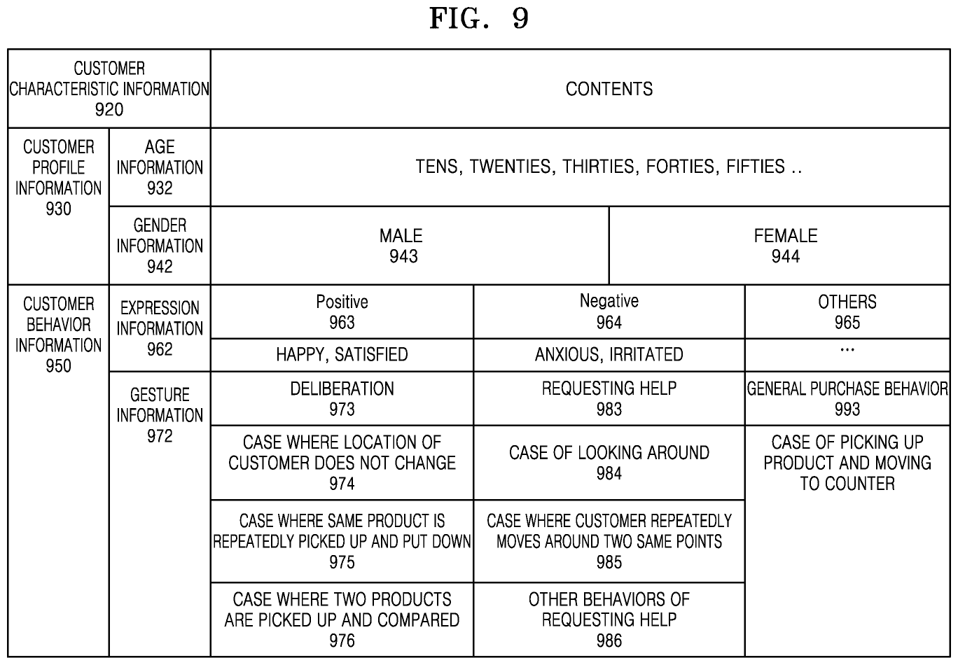

FIG. 9 is a table illustrating example profile information and behavior information of a customer which an electronic device acquires, according to various embodiments.

For example, customer profile information 930 acquired by the electronic device 1000 may include at least one of age information 932 and gender information 942. For example, the electronic device 1000 may acquire the customer profile information 930 including the age information 932 and the gender information 942 by analyzing an image of a customer, which is acquired from at least one camera in a store. The electronic device 1000 may acquire profile information including customer age information and customer gender information based on facial features in the image. According to an embodiment, the customer profile information 930 may further include expression information 962.

According to an embodiment, the age information 932 acquired by the electronic device 1000 may include information about facial features for each age. In addition, the gender information 942 may include information about a gender according to facial features. For example, the electronic device 1000 may determine a response method so that a mobile robot in the store responds to a customer for young customers (e.g., customers in their tens to thirties), but when old customers (e.g., in their forties or more) visit the store, the electronic device 1000 may determine a response method so that a clerk in the store responds to the customers.

According to an embodiment, the electronic device 1000 may determine a response subject according to age information 932 or gender information 942 of a customer. The electronic device 1000 may provide information for adjusting the numbers of mobile robots and clerks for responding to customers in the store (e.g., information about a ratio of the number of mobile robots to the number of clerks in the store), based on at last one of the age information or the gender information of the customers.

According to an embodiment, the electronic device 1000 may acquire at least one of expression information 962 of a customer and gesture information 972 of the customer based on at least one of facial features and body features of the customer in an image. Customer behavior information 950 acquired by the electronic device 1000 may include at least one of the expression information 962 and the gesture information 972. For example, the expression information may include information related to positive expressions 963 and information related to negative expressions 964 but is not limited thereto, and may include information related to other necessary expressions of a customer. According to an embodiment, the expression information 962 may be included in the customer profile information.

For example, when a customer looks smile or has left and right corners of a mouth turning up, the electronic device 1000 may determine the expression information of the customer as information related to the positive expressions 963. In addition, when a customer looks angry, has left and right corners of a mouth turning down, or having corners of eyes turning down, the electronic device 1000 may determine the expression information 962 of the customer as information related to the negative expressions 964.

According to an embodiment, the gesture information 972 may largely include a gesture 973 indicating deliberation, a gesture 983 for requesting help, and a gesture 993 related to a general purchase behavior but is not limited thereto. For example, based on body features of a customer, in a case 974 where a location of the customer does not change, a case 975 where the customer repeatedly picks up and takes down a same product, or a case 976 where the customer picks up and compares two types of products, the electronic device 1000 may determine the gesture information of the customer as the gesture 973 indicating deliberation.

In addition, based on body features of a customer, in a case 984 where the customer looks around, a case 985 where the customer repeatedly moves around two same points, or a case 986 where the customer performs other behaviors of requesting help, the electronic device 1000 may determine the gesture information 972 of the customer as the gesture 964 for requesting help. In addition, based on body features of a customer in an image, in a case where the customer moves to a counter with a product, the electronic device 1000 may determine the gesture information 972 of the customer as the gesture 993 related to a general purchase behavior. However, customer gesture information used by the electronic device is not limited to the example of FIG. 9.

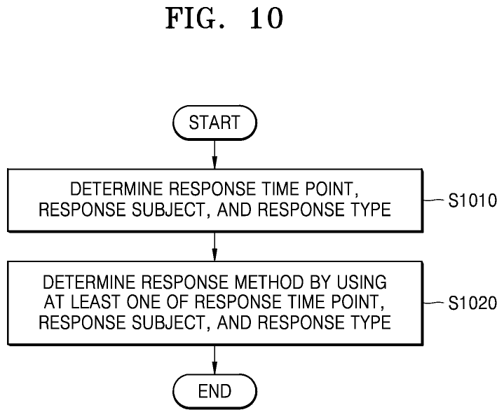

FIG. 10 is a flowchart illustrating an example method, performed by an electronic device, of determining a response method, according to various embodiments.

In operation S1010, the electronic device 1000 may determine a response time point, a response subject, and a response type. According to an embodiment, the electronic device 1000 may determine a response time point for responding to a customer, a response subject for responding to the customer, and a response type based on an identified displayed product. According to an embodiment, the electronic device 1000 may determine the response time point, the response subject, and the response type based on profile information, behavior information, and preference information of a customer.

For example, when the expression information 962 of a customer in an image is determined as information related to the negative expression 964, or the gesture information 972 of the customer is determined as the gesture 973 indicating deliberation or the gesture 983 for requesting help, the electronic device 1000 may determine a response time point, which is a time point for providing a response service to the customer, to be early. That is, when a customer is angry or irritated or needs help, the electronic device 1000 may determine a response time point as “early” or “immediately” to aggressively solve inconvenience of the customer.

According to an embodiment, when age information of a customer in an image is determined as tens to thirties, the electronic device 1000 may determine, as a mobile robot, a response subject for providing a response service to the customer. However, when the age information of the customer in the image is determined as thirties or more, the electronic device 1000 may determine the response subject as a clerk. That is, the electronic device 1000 may provide a customer-customized response method by setting a different response subject for each customer's age. According to an embodiment, the electronic device 1000 may determine a response type as ‘product guidance’ when gesture information of a customer in an image indicates the gesture 973 indicating deliberation, but determine the response type as ‘product guidance’ or ‘store guidance’ when the gesture information of the customer in the image indicates the gesture 983 for requesting help.

In operation S1020, the electronic device 1000 may determine a response method using at least one of the response time point, the response subject, and the response type. According to an embodiment, when a customer identified in a store is female in her sixties, the expression information 962 of the customer is determined as information related to the negative expression 964, and the gesture information 972 is determined as gesture information for requesting help, the electronic device 1000 may provide a response method including a response time point as ‘immediately’, a response subject as ‘clerk’, and a response type as ‘store guidance and product description’. That is, the electronic device 1000 may provide the response method including the response time point as ‘immediately’, the response subject as ‘clerk’, and the response type as ‘store guidance and product description’ to a terminal which the clerk carries, and the clerk may acquire the response method including the response time point as ‘immediately’, the response subject as ‘clerk’, and the response type as ‘store guidance and product description’ from the terminal and then provide a response service to the customer in the store.

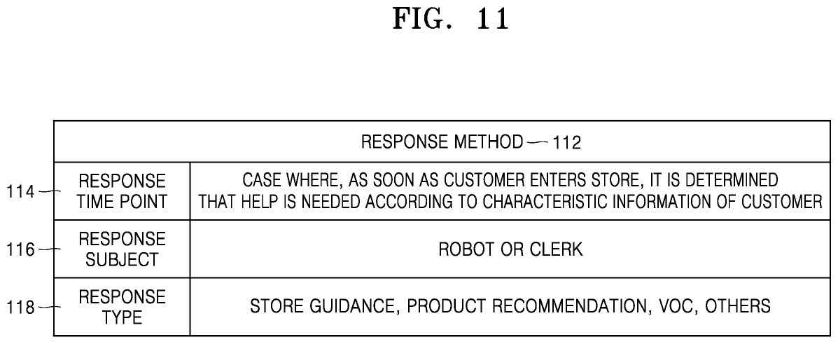

FIG. 11 is a table illustrating an example method, performed by an electronic device, of determining a response method, according to various embodiments.

The electronic device 1000 may determine a response method 112 using at least one of a response time point 114, a response subject 116, and a response type 118. According to an embodiment, the response time point 114 may include ‘immediately’, ‘after a preset time elapses from a time point when a customer enters an area in which a displayed product at which the customer is gazing is displayed’, ‘when the customer directly requests help’, ‘after a preset time elapses from a time point when the customer enters a store’, or the like but is not limited thereto. In addition, the response subject 116 may include ‘clerk’ or ‘mobile robot’ but is not limited thereto. In addition, according to an embodiment, the response method may include ‘product description’, ‘store guidance’ or ‘product description and store guidance’ but is not limited thereto. A particular method, performed by the electronic device 1000, of determining the response time point based on profile information of a customer, behavior information, preference information of the customer, and the like corresponds to operation S1010 of FIG. 10, and thus, a detailed description thereof is omitted herein.

According to an embodiment, the response subject 116 may include a mobile robot for providing a customer response service or a clerk. For example, the electronic device 1000 may determine, as the mobile robot, the response subject for providing a response service to a customer when age information of the customer in an image is determined as tens to thirties, and determine the response subject as the clerk when the age information of the customer in the image is determined as thirties or more. That is, the electronic device 1000 may provide a customer-customized response method by setting a different response subject for each customer's age.

According to an embodiment, the electronic device 1000 may determine, as the mobile robot, the response subject for providing a response service when the customer in the image is identified as male, and determine, as the clerk, the response subject for providing the response service when the customer in the image is identified as female. According to an embodiment, the electronic device 1000 may determine the response subject as the clerk when the expression information 962 of the customer in the image is determined as information related to the negative expression 964 or the gesture information 972 of the customer is determined as the gesture 973 indicating deliberation or the gesture 983 for requesting help. That is, the electronic device 1000 may set a different response subject for providing a response service, according to the customer profile information 930 and the customer behavior information 950.

According to an embodiment, the response type 118 indicating information related to a type of a response service to be provided by the electronic device 1000 may include at least one of store guidance, product description, product recommendation, and voice of communication (VOC). For example, when the gesture information of a customer is determined as the gesture 973 indicating deliberation or the gesture 983 for requesting help, the electronic device 1000 may determine the response type 118 as ‘product guidance’ or ‘store guidance’. According to an embodiment, when the gesture information 972 of a customer is determined as the general purchase behavior 993, the electronic device 1000 may determine the response type 118 as ‘counter location guidance’ or ‘payment service providing guidance’.

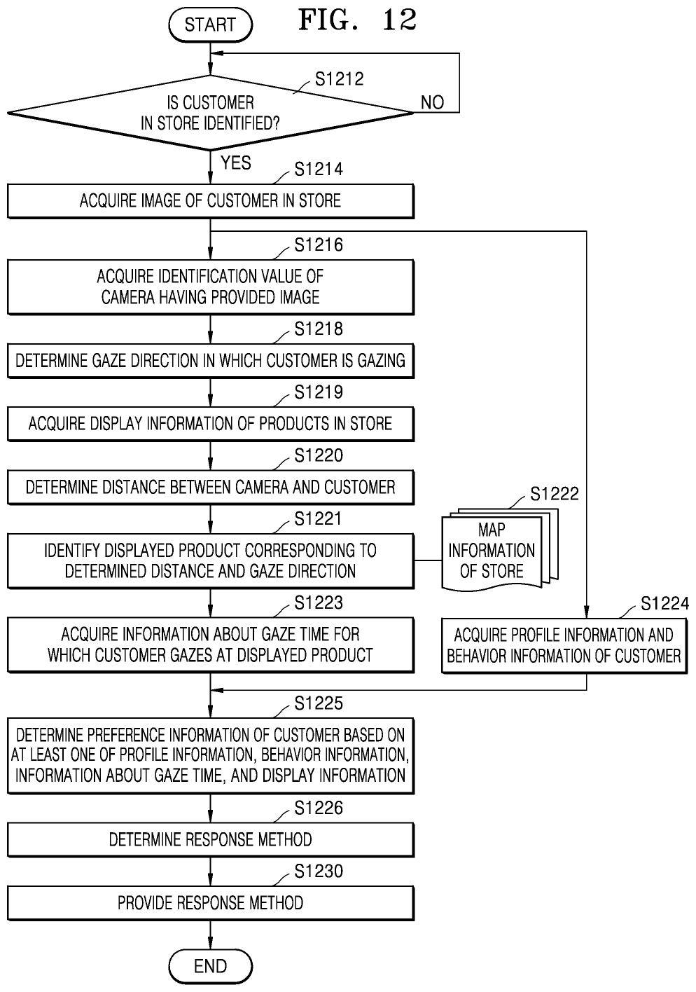

FIG. 12 is a flowchart illustrating an example method, performed by an electronic device, of providing a response method for a customer, according to an embodiment.

In operation S1212, the electronic device 1000 may identify a customer using at least one camera in a store. For example, the electronic device 1000 may be connected to the at least one camera in the store in a wired or wireless manner, and may identify the customer when the customer enters the store or enters a predetermined display area in the store, which is identified by a display stand. In operation S1214, the electronic device 1000 may acquire an image of the customer in the store if a customer is identified as being in the store (“YES” in operation S1212). For example, the electronic device 1000 may continuously acquire images of the customer using the at least one camera in the store, until the customer having entered the store leaves the store.

In operation S1216, the electronic device 1000 may acquire an identification value of a camera having provided the image of the customer. For example, the at least one camera in the store may include a unique identification value, and electronic device 1000 may identify a camera in the store using a unique identification value of the camera. In operation S1218, the electronic device 1000 may determine a gaze direction in which the customer in the image is gazing. For example, the electronic device 1000 may determine the gaze direction based on facial features of the customer in the image. A method, performed by the electronic device 1000, of determining the gaze direction may correspond to operation S330 of FIG. 3, and thus, a detailed description thereof is omitted herein.

In operation S1219, the electronic device 1000 may acquire display information of products in the store. The electronic device 1000 may previously store the display information in a memory in the electronic device 1000 or acquire the display information from a store server or another store management server connected to the store server. The display information may include at least one of information about locations of the products displayed in the store, information about locations of display stands for displaying the products, predetermined display areas in the store identified by the display stands, and information about a location of a camera for acquiring the image of the customer.

In operation S1220, the electronic device 1000 may determine a distance between the camera and the customer. Operation S1220 may correspond to operation S710 of FIG. 7, and thus, a detailed description thereof may not be repeated here. In operation S1221, the electronic device 1000 may identify a displayed product corresponding to the determined distance and the determined gaze direction. For example, the electronic device 1000 may identify a displayed product at which the customer is gazing, by mapping a location in the store corresponding to the determined distance and the determined gaze direction to map information of the store S1222, which is included in the acquired display information. Operation S1221 may correspond to operation S730 of FIG. 7, and thus, a detailed description thereof may not be repeated here.

In operation S1223, the electronic device 1000 may acquire information about a gaze time for which the customer gazes at the displayed product. Operation S1223 may correspond to operation S830 of FIG. 8, and thus, a detailed description thereof may not be repeated here. In operation S1224, the electronic device 1000 may acquire profile information and behavior information of the customer. According to an embodiment, the electronic device 1000 may not only identify the displayed product based on the gaze direction in which the customer is gazing but also further acquire at least one of expression information, age information, gender information, and gesture information of the customer.

In operation S1225, the electronic device 1000 may determine preference information of the customer based on at least one of the profile information, the behavior information, the information about the gaze time, and the display information. That is, the electronic device 1000 may identify a displayed product which the customer most prefers, based on the information about the gaze time and the display information and provide a customized customer response method by further acquiring the profile information including age information and gender information of the customer and the behavior information including expression information and gesture information.

In operation S1226, the electronic device 1000 may determine a response time point, a response subject, and a response type based on the determined preference information of the customer and determine a response method using at least one of the determined response time point, response subject, and response type. In operation S1230, the electronic device 1000 may provide the determined response method to a terminal which a clerk carries or a mobile robot.

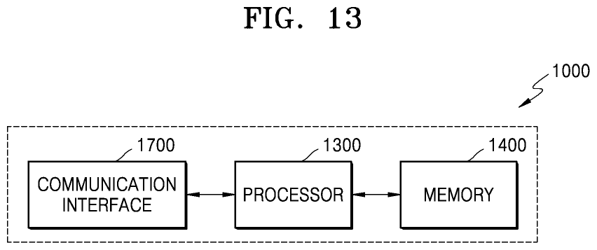

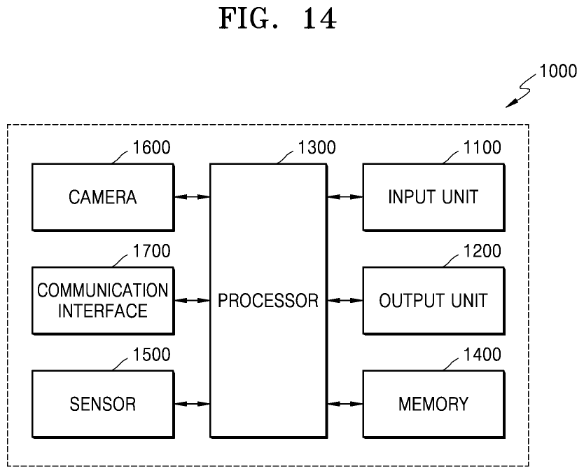

FIGS. 13 and 14 are block diagrams illustrating example configurations of the electronic device for providing a response method for a customer in a store, according to various embodiments.

As shown in FIG. 13, the electronic device 1000 according to an embodiment may include a communication processor (e.g., including processing circuitry) 1300, a memory 1400, and a communication interface (e.g., including communication circuitry) 1700. However, all of the shown components are not essential components. The electronic device 1000 may be implemented by more or less components than the shown components. For example, as shown in FIG. 14, the electronic device 1000 according to an embodiment may further include an input unit (e.g., including input circuitry) 1100, an output unit (e.g., including output circuitry) 1200, the processor 1300, the memory 1400, a sensor 1500, a camera 1600, and the communication interface 1700.

The input unit 1100 may indicate various circuitry through which a user inputs data for controlling the electronic device 1000. For example, the input unit 1100 may include a keypad, a dome switch, a touch pad (a capacitive overlay touch pad, a resistive overlay touch pad, an infrared (IR) beam touch pad, a surface acoustic wave touch pad, an integral strain gauge touch pad, a piezoelectric touch pad, or the like), a jog wheel, a jog switch, and the like but is not limited thereto.

The input unit 1100 may include various circuitry and receive a user input needed for the electronic device 1000 to determine a response method for a customer in a store. For example, when latest display information is not stored in the electronic device 1000, the input unit 1100 may receive a user input for commanding downloading of display information from a store management server or the like. In addition, the input unit 1100 may directly receive, from the user, age information, gender information, expression information, gesture information, and the like of the user matched with at least one of facial features or body features of the customer in an image.

The output unit 1200 may include various circuitry and output an audio signal, a video signal, or a vibration signal and may include a display (not shown), an acoustic output unit (not shown), and a vibration motor (not shown). For example, the output unit 1200 may output an alarm when the customer enters the store or when a response method for the customer in the store is finally determined.

The display includes a screen for displaying information processed by the electronic device 1000. In addition, the screen may display an image. For example, at least a portion of the screen may display map information of the store, which includes locations of products displayed in the store, locations of display stands, and the like, preference information of the customer, a response method, and the like.

The output unit may include various circuitry and output audio data received through the communication interface 1700 or stored in the memory 1400. In addition, the acoustic output unit may output an acoustic signal related to a function (e.g., a call signal reception sound, a message reception sound, or an alarm sound) performed by the electronic device 1000.

The processor 1300 may include various processing circuitry and commonly control a general operation of the electronic device 1000. For example, the processor 1300 may generally control the input unit 1100, the output unit 1200, the sensor 1500, the communication unit 1700, the camera 1600, and the like by executing programs stored in the memory 1400. In addition, the processor 1300 may perform the functions of the electronic device 1000 described with reference to FIGS. 1 to 12 by executing the programs stored in the memory 1400.

Particularly, the processor 1300 may acquire an image by photographing the customer from at least one camera provided in the store by controlling the communication interface 1700. In addition, the processor 1300 may acquire an identification value of a camera having provided the image and determine a gaze direction in which the customer is gazing, based on facial features of the customer in the image. In addition, the processor 1300 may acquire display information of products in the store and identify a displayed product corresponding to the gaze direction among displayed products around the camera based on the display information.

According to an embodiment, the processor 1300 may identify a facial area of the customer in the image using a pre-trained neural network model, determine at least one object in the identified facial area, and identify a direction of a face of the customer and a direction of a pupil in the face using the at least one object. In addition, the processor 1300 may determine the gaze direction using at least one of the identified direction of the face and the identified direction of the pupil.

According to an embodiment, the processor 1300 may determine a location of the camera having provided the image by mapping the acquired identification value of the camera to the display information, identify a location of the customer in the image, and identify a displayed product corresponding to the identified location of the customer, the determined location of the camera, and the gaze direction.

According to an embodiment, the processor 1300 may determine a distance between the camera and the customer based on the location of the customer in the image and the determined location of the camera, identify a location in the store corresponding to the determined distance and the gaze direction, and identify the displayed product by mapping, to the display information, the location in the store corresponding to the determined distance and the gaze direction. According to an embodiment, the processor 1300 may acquire expression information, age information, gender information, and gesture information of the customer in the image using the pre-trained neural network model.

According to an embodiment, the processor 1300 may acquire profile information of the customer based on the facial features of the customer in the image, acquire behavior information of the customer based on body features of the customer in the image, and determine preference information of the customer based on at least one of the behavior information, the profile information, information about a gaze time, and the display information.

According to an embodiment, the processor 1300 may determine a response time point, a response subject, and a response type for responding to the customer based on the profile information, the behavior information, and the preference information of the customer and determine a response method using at least one of the determined response time point, response subject, and response type.

The memory 1400 may store programs for processing and control of the processor 1300 and store data input to the electronic device 1000 or to be output from the electronic device 1000. In addition, the memory 1400 may store an image of the customer in the store, which is acquired by the electronic device 1000, and information about the facial features and the body features of the customer, which is determined from the image. According to an embodiment, the memory 1400 may store the age information, the expression information, the gender information, and the gesture information of the customer so as to be matched with at least one of the facial features and the body features of the customer. In addition, the memory 1400 may further store information related to a response time, a response subject, and a response type determined for each customer.

In addition, the memory 1400 may further store information about a neural network trained based on image data of customers, layers for specifying a structure of the neural network, and weights among the layers. In addition, the memory 1400 may further store updated display information when the display information in the store is updated.

The memory 1400 may include at least one type of storage medium among a flash memory type memory, a hard disk type memory, a multimedia card micro type memory, a card type memory (e.g., a secure digital (SD) or extreme digital (XD) memory), random access memory (RAM), static RAM (SRAM), read only memory (ROM), electrically erasable programmable ROM (EEPROM), PROM, a magnetic memory, a magnetic disc, and an optical disc. The programs stored in the memory 1400 may be classified into a plurality of modules according to functions thereof, e.g., a user interface (UI) module, a touchscreen module, an alarm module, and the like.

The UI module may provide a specified UI, a specified graphics UI (GUI), or the like interoperating with the electronic device 1000 for each application. The touchscreen module may sense a touch gesture of the user on a touchscreen and transmit information regarding the touch gesture to the processor 1300. According to some embodiments, the touchscreen module may recognize and analyze a touch code. The touchscreen module may be configured by separate hardware including a controller.

The alarm module may generate a signal for informing of the occurrence of an event of the electronic device 1000. Examples of the event occurring in the electronic device 1000 may include call signal reception, message reception, key signal input, schedule notification, and the like. The alarm module may output an alarm signal in a video signal form through the display, an audio signal form through the acoustic output unit, or a vibration signal form through the vibration motor.

The sensor 1500 may sense a state of the electronic device 1000 or an ambient state of the electronic device 1000 and transmit the sensed information to the processor 1300. The sensor 1500 may be used to generate some of specification information of the electronic device 1000, state information of the electronic device 1000, ambient environment information of the electronic device 1000, state information of the user, and device use history information of the user.

The sensor 1500 may include at least one of a magnetic sensor, an acceleration sensor, a temperature/humidity sensor, an IR sensor, a gyroscope sensor, a position sensor (e.g., GPS) 1460, an atmospheric pressure sensor, a proximity sensor, or an RGB (illuminance) sensor but is not limited thereto. A function of each sensor may be intuitively inferred by those of ordinary skill in the art from a name thereof, and thus, a detailed description thereof is omitted herein.

The camera 1600 may acquire an image in the store. For example, the camera 1600 may be a CCTV capable of capturing an image in real-time but is not limited thereto. The at least one camera provided in the store may be a certain image capturing device capable of photographing a customer in the store. In addition, the camera 1600 may be connected to the electronic device 1000, the store management server, or the like in a wired or wireless manner and receive a captured image of the customer in real-time or at preset time intervals.

The communication interface 1700 may include at least one component including various communication circuitry for allowing the electronic device 1000 to communicate with a different device (not shown), a store server, another management server connected to the store server, and the like. The different device (not shown) may be a computing device, such as the electronic device 1000, or a sensing device but is not limited thereto. For example, the communication interface 1700 may include a short-range wireless communication unit, a mobile communication unit, and a broadcast reception unit.

The short-range wireless communication unit may include a Bluetooth communication unit, a Bluetooth low energy (BLE) communication unit, a near-field communication unit, a wireless local area network (WLAN) (Wi-Fi) communication unit, a ZigBee communication unit, an infrared data association (IrDA) communication unit, a Wi-Fi Direct (WFD) communication unit, an ultra-wideband (UWB) communication unit, an Ant+ communication unit, and the like but is not limited thereto.

The mobile communication unit transmits and receives a wireless signal to and from at least one of a base station, an external terminal, and a server in a mobile communication network. Herein, the wireless signal may include a voice call signal, a video call signal, or various types of data according to text/multimedia message transmission and reception.

The broadcast reception unit receives a broadcast signal and/or broadcast related information from the outside through a broadcast channel. The broadcast channel may include a satellite channel and a terrestrial channel. According to implementation examples, the electronic device 1000 may not include the broadcast reception unit. In addition, the communication interface 1700 may acquire an image of the customer from the at least one camera in the store. According to an embodiment, the communication interface 1700 may acquire display information from a management server or another electronic device in the store. In addition, the communication interface 1700 may transmit a response method determined by the electronic device 1000 to a terminal which a clerk carries or a mobile robot in the store.

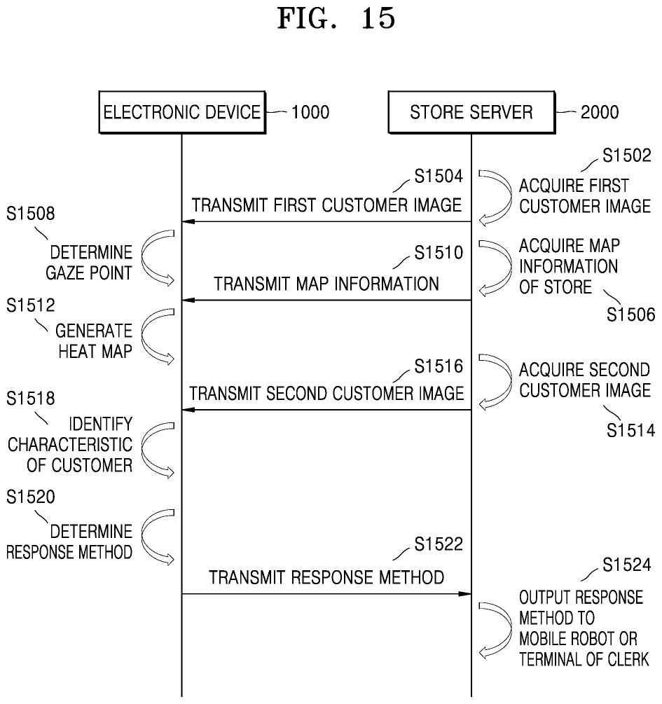

FIG. 15 is a signal flow diagram illustrating an example method, performed by an electronic device, of providing a response method for a customer using a store server, according to various embodiments.

In operation S1502, a store server 2000 may acquire a first customer image from at least one camera in a store. In operation S1504, the store server 2000 may transmit the acquired first customer image to the electronic device 1000.

In operation S1506, the store server 2000 may acquire map information of the store. According to an embodiment, the map information of the store may be included in the display information in operation S1219 of FIG. 12. In operation S1508, the electronic device 1000 may determine a gaze point at which a customer is gazing. In operation S1510, the store server 2000 may transmit the acquired map information to the electronic device 1000.

In operation S1512, the electronic device 1000 may generate a heat map by mapping, to the acquired map information, the gaze point at which the customer is gazing. For example, the electronic device 1000 may generate preference information of the customer for each display area or each displayed product based on information about a gaze time for which the customer gazes at the determined gaze point. The preference information of the customer, which is generated by the electronic device 1000, may be generated in a heat map form.

In operation S1514, the electronic device 1000 may acquire a second customer image. According to an embodiment, the second customer image acquired by the electronic device 1000 may be an image of the customer, which is acquired at a different time from a time at which the first customer image was acquired. In operation S1516, the store server 2000 may transmit the acquired second customer image to the electronic device 1000. In operation S1518, the electronic device 1000 may identify a characteristic of the customer based on facial features or body features of the customer in the acquired second customer image. For example, the electronic device 1000 may identify at least one of age information, gender information, expression information, and gesture information of the customer as the characteristic of the customer

The electronic device 1000 may manage the identified age information and gender information of the customer as profile information of the customer, and manage the expression information and the gesture information of the customer as behavior information. According to an embodiment, the expression information may be managed as the profile information of the customer. In operation S1520, the electronic device 1000 may determine a response time point, a response subject, and a response type based on the profile information, the behavior information, and the preference information of the customer and determine a response method using at least one of the determined response time point, response subject, and response type. In operation S1522, the electronic device 1000 may transmit the determined response method to the store server 2000. In operation S1524, the store server 2000 may transmit the response method to a mobile robot or a terminal of a clerk to perform a control so that the mobile robot or the terminal which the clerk carries outputs the response method.

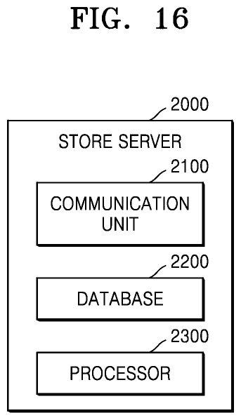

FIG. 16 is a block diagram illustrating an example configuration of the store server according to various embodiments.

The store server 2000 according to an embodiment may include a communication unit interface (e.g., including communication circuitry) 2100, a database (DB) 2200, and a processor (e.g., including processing circuitry) 2300.

The communication unit interface 2100 may include at least one component including various communication circuitry configured to communicate with the electronic device 1000. The communication interface 2100 may receive preference information of a customer, a heat map, and a response method from the electronic device 1000. According to an embodiment, the communication interface 2100 may transmit, to the electronic device 1000, an image of the customer or an image in a store, which is acquired from at least one camera. In addition, the communication interface 2100 may transmit display information of the store or map information of the store to the electronic device 1000.

The DB 2200 may store the display information of the store, the map information of the store, information about locations and a list of products in the store, information about locations of display stands on which the products are displayed in the store, profile information and behavior information of the customer matched with facial features or body features, and the like.

The processor 2300 may include various processing circuitry and commonly controls a general operation of the store server 2000. For example, the processor 2300 may generally control the DB 2200, the communication unit interface 2100, and the like by executing programs stored in the DB 2200 of the store server 2000. The processor 2300 may perform some of the operations of the electronic device 1000 in FIGS. 1 to 12 by executing the programs stored in the DB 2200.

Various embodiments may be implemented in a form of a recording medium including computer-executable instructions such as a program module executed by a computer system. Computer-readable media may be arbitrary available media which may be accessed by a computer system and include all types of volatile and non-volatile media and separated and non-separated media. In addition, the computer-readable media may include all types of computer storage media and communication media. Computer storage media include all types of volatile and non-volatile and separated and non-separated media implemented by an arbitrary method or technique for storing information such as computer-readable instructions, a data structure, a program module, or other data.

In addition, in the present disclosure, “unit” may indicate a hardware component such as a processor or a circuit and/or a software component executed by a hardware component such as a processor.

The embodiments of the present disclosure described above are only illustrative, and it will be understood by those of ordinary skill in the art to which the present disclosure belongs that various changes in form and details may be made therein without changing the technical spirit and features of the present disclosure. Therefore, the embodiments described above should be understood in the illustrative sense only and not for the purpose of limitation in all aspects. For example, each component described as a single type may be carried out by being distributed, and likewise, components described as a distributed type may also be carried out by being coupled.

While one or more embodiments of the disclosure have been described with reference to the figures, it will be understood by those of ordinary skill in the art that various changes in form and details may be made therein without departing from the spirit and scope of the disclosure, including the following claims.

What is claimed is:

1. A method, performed by an electronic device, of providing a response method for a customer, the method comprising:
acquiring a captured image of the customer from at least one camera;
acquiring an identification value of a camera having provided the image;
determining a gaze direction in which the customer is gazing, based on facial features of the customer in the image;
acquiring display information about products;
identifying a displayed product corresponding to the gaze direction among displayed products around the camera, based on the display information; and
providing a response method related to the displayed product.

2. The method of claim 1, wherein the determining of the gaze direction comprises:
identifying a facial area of the customer in the image;
determining at least one object in the identified facial area;
identifying at least one of a direction of a face of the customer and a direction of a pupil in the face using the at least one object; and
determining the gaze direction using the identified at least one of the direction of the face and the direction of the pupil.

3. The method of claim 1, wherein the identifying of the displayed product comprises:
determining a location of the camera having provided the image by mapping the acquired identification value to the display information;
identifying a location of the customer in the image; and
identifying the displayed product corresponding to the identified location of the customer, the determined location of the camera, and the gaze direction.

4. The method of claim 3, wherein the identifying of the displayed product comprises:
determining a distance between the camera and the customer based on the location of the customer in the image and the determined location of the camera;
identifying a location corresponding to the determined distance and the gaze direction; and
identifying the displayed product by mapping, to the display information, the location corresponding to the determined distance and the gaze direction.

5. The method of claim 1, further comprising:
acquiring profile information of the customer based on the facial features of the customer in the image;
acquiring information about a gaze time for which the customer gazes at the displayed product;
determining preference information of the customer about the displayed product based on the profile information, the information about the gaze time, and the display information; and
determining the response method based on the determined preference information of the customer.

6. The method of claim 5, further comprising:
acquiring behavior information of the customer based on at least one of the facial features and body features of the customer in the image; and
determining the preference information of the customer based on at least one of the acquired behavior information, the profile information, the information about the gaze time, and the display information.

7. The method of claim 1, wherein the providing of the response method comprises:
determining a response time point for responding to the customer, a response subject for responding to the customer, and a response type based on the identified displayed product; and
determining the response method using at least one of the response time point, the response subject, and the response type.

8. The method of claim 6, wherein the providing of the response method comprises:
determining a response time point for responding to the customer, a response subject for responding to the customer, and a response type, based on the profile information, the behavior information, and the preference information of the customer; and
determining the response method using at least one of the response time point, the response subject, and the response type.

9. The method of claim 5, wherein the preference information of the customer is generated in a map form reflecting information about the gaze time in the display information, and the preference information of the customer is generated for each predetermined display area and for each product.

10. The method of claim 5, wherein the display information comprises at least one of information about locations of the products displayed in the store, information about a locations of display stands for displaying the products, and information about a location of the camera for acquiring the image of the customer, and
further comprising providing guidance information for updating the display information, based on the acquired preference information of the customer.

11. The method of claim 6, wherein the profile information comprises at least one of age information of the customer and gender information of the customer, which are determined based on the facial features of the customer, and
the behavior information comprises at least one of expression information of the customer and gesture information of the customer, which are determined based on at least one of the facial features and the body features of the customer.

12. An electronic device for providing a response method for a customer, the electronic device comprising:
a communication interface comprising communication circuitry;
a memory storing one or more instructions; and
a processor configured to control the electronic device by executing the one or more instructions,
wherein the processor is configured to:
acquire a captured image of the customer from at least one camera,
acquire an identification value of a camera having provided the image,
determine a gaze direction in which the customer is gazing, based on facial features of the customer in the image,
acquire display information about products,
identify a displayed product corresponding to the gaze direction among displayed products around the camera, based on the display information, and
provide a response method related to the identified displayed product.

13. The electronic device of claim 12, wherein the processor is further configured to:
identify a facial area of the customer in the image,
determine at least one object in the identified facial area,
identify at least one of a direction of a face of the customer and a direction of a pupil in the face using the at least one object, and
determine the gaze direction using the identified at least one of the direction of the face and the direction of the pupil.

14. The electronic device of claim 12, wherein the processor is further configured to: determine a location of the camera having provided the image, by mapping the acquired identification value to the display information,
identify a location of the customer in the image, and
identify the displayed product corresponding to the identified location of the customer, the determined location of the camera, and the gaze direction.

15. The electronic device of claim 14, wherein the processor is further configured to: determine a distance between the camera and the customer based on the location of the customer in the image and the determined location of the camera,
identify a location corresponding to the determined distance and the gaze direction, and
identify the displayed product by mapping, to the display information, the location corresponding to the determined distance and the gaze direction.

16. The electronic device of claim 12, wherein the processor is further configured to: acquire profile information of the customer based on the facial features of the customer in the image,
acquire information about a gaze time for which the customer gazes at the displayed product,
determine preference information of the customer about the displayed product, based on the profile information, the information about the gaze time, and the display information, and
determine the response method based on the determined preference information of the customer.

17. The electronic device of claim 16, wherein the processor is further configured to: acquire behavior information of the customer based on body features of the customer in the image, and
determine the preference information of the customer based on at least one of the acquired behavior information, the profile information, the information about the gaze time, and the display information.

18. The electronic device of claim 16, wherein the processor is further configured to: determine a response time point for responding to the customer, a response subject for responding to the customer, and a response type, based on the profile information, the behavior information, and the preference information of the customer and
determine the response method using at least one of the response time point, the response subject, and the response type.

19. The electronic device of claim 17, wherein the preference information of the customer is generated in a map form reflecting the information about the gaze time in the display information, the preference information of the customer is generated for each predetermined display area and for each product,
the display information comprises at least one of information about locations of the products displayed in the store, information about locations of display stands for displaying the products, and information about a location of the camera for acquiring the image of the customer,
the profile information comprises at least one of age information of the customer and gender information of the customer, which are determined based on the facial features of the customer,
the behavior information comprises at least one of expression information of the customer and gesture information of the customer, which are determined based on at least one of the facial features and the body features of the customer, and
the processor is further configured to provide guidance information for updating the display information, based on the acquired preference information of the customer.

20. A computer program product comprising a non-transitory computer-readable recording medium having recorded thereon a program for performing operations of:
acquiring a captured image of a customer from at least one camera;
acquiring an identification value of a camera having provided the image;
determining a gaze direction in which the customer is gazing, based on facial features of the customer in the image;
acquiring display information about products;
identifying a displayed product corresponding to the gaze direction among displayed products around the camera, based on the display information; and
providing a response method related to the displayed product.
